(19) United States
(12) Patent Application Publication
(10) Pub. No.: US 2009/0104371 A1
(43) Pub. Date: Apr. 23, 2009

(54) FILM FORMING COMPOSITION, METHOD FOR PRODUCING FILM, FILM, AND INSULATING FILM

(75) Inventors: Hidetoshi Hiraoka, Shizuoka (JP); Makoto Muramatsu, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/211,125

(22) Filed: Sep. 16, 2008

(30) Foreign Application Priority Data
Sep. 27, 2007 (JP) 2007-250513
Sep. 27, 2007 (JP) 2007-250525

(51) Int. Cl. B05D 3/06; C08F 4/34; C08F 4/04; C08F 4/00; C08L 49/00; C08K 3/36; B05D 5/12

(52) U.S. Cl. 427/551; 526/232; 526/218.1; 526/208; 526/211; 524/550; 427/58; 427/553

(57) ABSTRACT

A film forming composition is provided that includes (A) a radical polymerization initiator, and (B-1) a compound represented by Formula (1) below and/or a polymer polymerized using at least a compound represented by Formula (1) below, and/or (B-2) a compound represented by Formula (2) below and/or a polymer polymerized using at least a compound represented by Formula (2) below

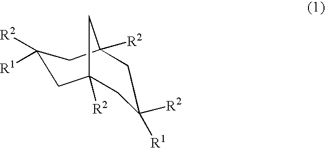

(in Formula (1), the two R¹s denote groups consisting only of carbon and hydrogen, which may be identical to or different from each other, and may be linked to each other to form a 6- or higher-membered ring structure, and the R²s denote hydrogen atoms or are represented by Formula (3) below and may be identical to or different from each other provided that at least one of the R²s is represented by Formula (3))

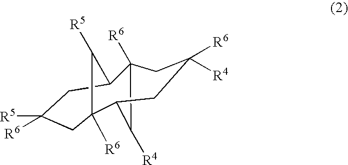

(in Formula (2), the two R⁴s and the two R⁵s denote groups consisting only of carbon and hydrogen, which may be identical to or different from each other, R⁴ and R⁴, and R⁵ and R⁵ may be linked to each other to form a 6- or higher-membered ring structure, and the R⁶s denote hydrogen atoms or are represented by Formula (3) and may be identical to or different from each other provided that at least one R⁶ is represented by Formula (3))

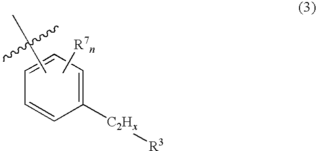

(in Formula (3), the two carbon atoms in C₂Hₓ are linked via a double bond or a triple bond, x denotes 0 or 2, R³ denotes a hydrogen atom, an alkyl group, an aryl group, a substituted aryl group, a heteroaryl group, an aryl ether group, an alkenyl group, or an alkynyl group, n is 4, and the n R⁷s may be identical to or different from each other and denote a hydrogen atom, an alkyl group, an aryl group, a substituted aryl group, or a halogen atom). There are also provided a process for producing a film using the composition and a film obtained by the process.

### BACKGROUND OF THE INVENTION

1. Field of the Invention

The present invention relates to a film forming composition, a process for producing a film using the film forming composition, and a film and an insulating film obtained from the composition and the production process.

2. Description of the Related Art

In recent years, in the field of electronic materials, accompanying progress in high integration, multifunctionalization, and high performance, circuit resistance and inter-wiring capacitance have increased, thus causing increases in power consumption and delay time. In particular, since the increase in delay time is the main cause of a decrease in signal speed or the occurrence of crosstalk in a device, in order to reduce the delay time and increase the device speed there is a need to reduce parasitic resistance and parasitic capacitance. As a specific measure for reducing the parasitic capacitance, covering the area around the wiring with a low permittivity interlayer insulating film has been attempted. Furthermore, the interlayer insulating film is required to have excellent heat resistance such that it can withstand a thin film formation step when producing a package substrate or a back end step such as chip connection or pin attachment, or to have excellent chemical resistance such that it can withstand a wet process. Moreover, in recent years Cu wiring, which has low resistance, has been introduced to replace Al wiring; accompanying this, planarization by CMP (chemical mechanical polishing) is commonly carried out, and high mechanical strength that allows the film to withstand this process is needed.

As compounds exhibiting low permittivity, polymers formed from saturated hydrocarbons are generally cited. These polymers have lower molar polarization than polymers formed from a heteroatom-containing unit or an aromatic hydrocarbon unit, and therefore exhibit low permittivity. However, hydrocarbons having high flexibility such as polyethylene do not have sufficient heat resistance and cannot be used in an electronic device.

In contrast thereto, a polymer having introduced into the molecule adamantane or diamantane, which are saturated hydrocarbons with a rigid cage structure, has been disclosed and it has been disclosed that it has low permittivity (JP-A-2003-292878; JP-A denotes a Japanese unexamined patent application publication).

### BRIEF SUMMARY OF THE INVENTION

It is an object of the present invention to provide a film forming composition that enables a film having excellent curability and low permittivity to be formed, a process for producing a film using the film forming composition, and a film and an insulating film using the film forming composition and the production process.

The objects of the present invention have been attained by means described in (1), (9), and (16). (2) to (8) and (10) to (15), which are preferred embodiments, are also shown below.

(1) A film forming composition comprising (A) a radical polymerization initiator, and (B-1) a compound represented by Formula (1) below and/or a polymer polymerized using at least a compound represented by Formula (1) below, and/or (B-2) a compound represented by Formula (2) below and/or a polymer polymerized using at least a compound represented by Formula (2) below

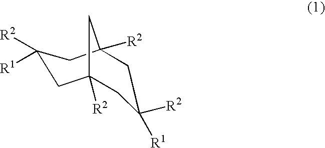

(in Formula (1), the two R¹s denote groups consisting only of carbon and hydrogen, which may be identical to or different from each other, and may be linked to each other to form a 6- or higher-membered ring structure, and the R²s denote hydrogen atoms or are represented by Formula (3) below and may be identical to or different from each other provided that at least one of the R²s is represented by Formula (3))

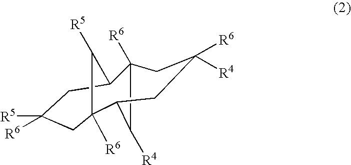

(in Formula (2), the two R⁴s and the two R⁵s denote groups consisting only of carbon and hydrogen, which may be identical to or different from each other, R⁴ and R⁴, and R⁵ and R⁵ may be linked to each other to form a 6- or higher-membered ring structure, and the R⁶s denote hydrogen atoms or are represented by Formula (3) and may be identical to or different from each other provided that at least one R⁶ is represented by Formula (3))

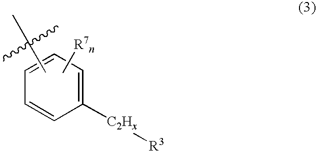

(in Formula (3), the two carbon atoms in C₂Hₓ are linked via a double bond or a triple bond, x denotes 0 or 2, R³ denotes a hydrogen atom, an alkyl group, an aryl group, a substituted aryl group, a heteroaryl group, an aryl ether group, an alkenyl group, or an alkynyl group, n is 4, and the n R⁷s may be identical to or different from each other and denote a hydrogen atom, an alkyl group, an aryl group, a substituted aryl group, or a halogen atom),
(2) the film forming composition according to (1), wherein the radical polymerization initiator comprises at least one selected from the group consisting of an organic peroxide, an organic azo compound, an alkylphenone compound, and an oxime ester compound,
(3) the film forming composition according to (1) or (2) above, wherein the compound represented by Formula (1) above is selected from the group consisting of Formula (1-1) to Formula (1-4) below,

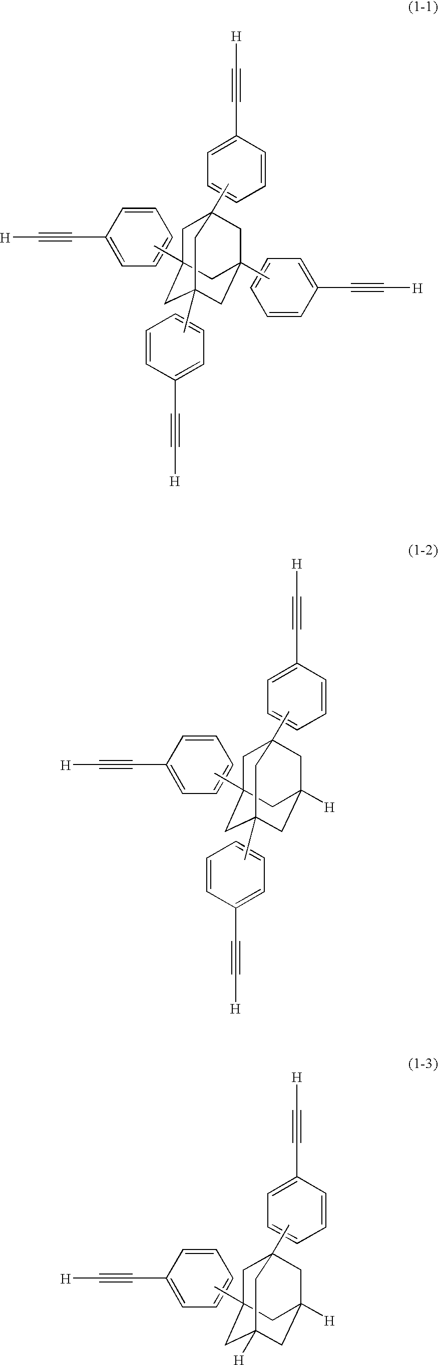

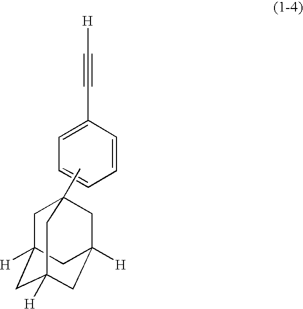

(4) the film forming composition according to any one of (1) to (3) above, wherein the compound represented by Formula (2) above is selected from the group consisting of Formula (2-1) to Formula (2-4) below,

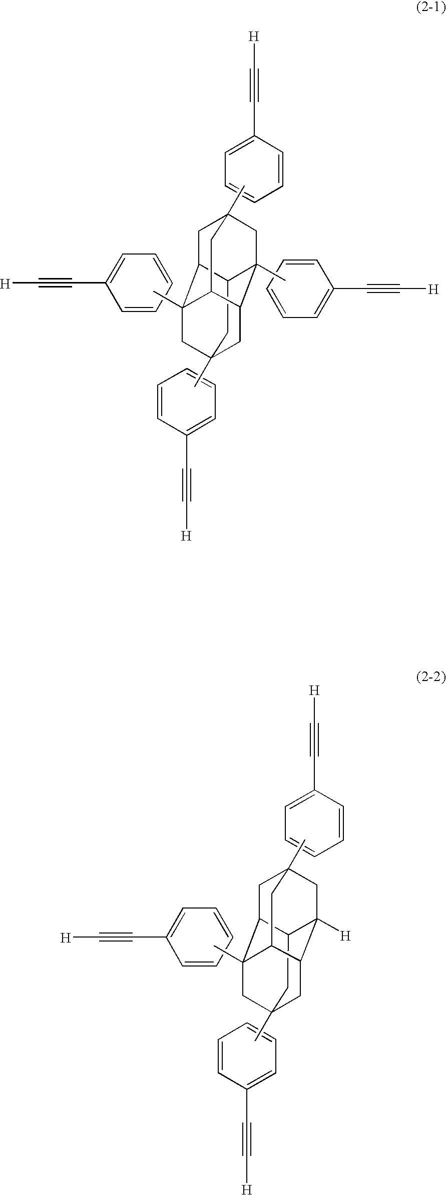

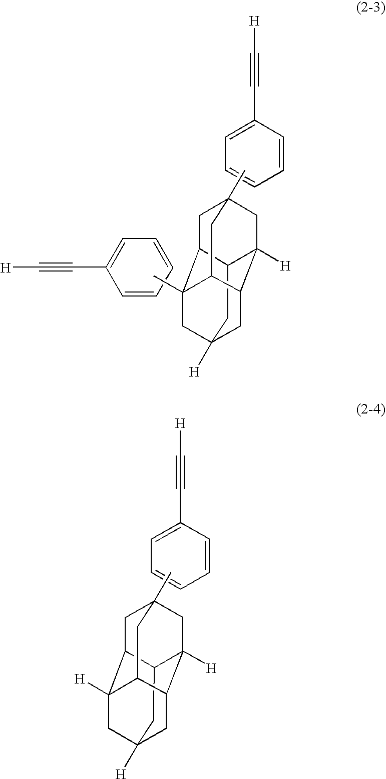

(5) the film forming composition according to any one of (1) to (4) above, wherein the total amount of component (B-1) and component (B-2) added is at least 0.1 wt % but no greater than 50 wt % of the total amount of the film forming composition,
(6) the film forming composition according to any one of (1) to (5) above, wherein it further comprises an organic solvent,
(7) the film forming composition according to any one of (1) to (6) above, wherein it further comprises at least one additive selected from the group consisting of colloidal silica, a surfactant, a silane coupling agent, an adhesion promoter, and a pore forming factor,
(8) the film forming composition according to any one of (1) to (7) above, wherein it is intended for use in forming an insulating film,
(9) a process for producing a film, the process comprising a step of preparing the film forming composition according to any one of (1) to (8) above, a step of applying the film forming composition in the form of a film, and at least one step selected from the group consisting of a step of heating the applied film forming composition, a step of irradiating the applied film forming composition with UV rays, and a step of irradiating the applied film forming composition with a high energy beam other than UV rays,
(10) the process according to (9) above, wherein it comprises a step of irradiating the applied film forming composition with UV rays,
(11) the process according to (9) or (10) above, wherein the UV rays have a wavelength of no greater than 500 nm,
(12) the process according to any one of (9) to (11) above, wherein the time of irradiation with UV rays is no greater than 3 minutes,
(13) the process according to any one of (9) to (12) above, wherein it comprises a step of heating the applied film forming composition and a step of irradiating the applied film forming composition with UV rays,
(14) the process according to (13) above, wherein it comprises a step of irradiating with a high energy beam other than UV rays,
(15) the process according to (9) to (14) above, wherein the film is an insulating film, and
(16) a film obtained by the process according to any one of (9) to (15) above.

### EFFECTS OF THE INVENTION

In accordance with the present invention, there can be provided a film forming composition that enables a film having excellent curability and low permittivity to be formed, a process for producing a film using the film forming composition, and a film and an insulating film using the film forming composition and the production process.

### DETAILED DESCRIPTION OF THE INVENTION

The present invention is explained in detail below.

### Film Forming Composition

The film forming composition of the present invention (in the present invention, also called simply the composition) comprises (A) a radical polymerization initiator, and (B-1) a compound represented by Formula (1) above and/or a polymer polymerized using at least a compound represented by Formula (1) above (hereinafter, also called component (B-1)) and/or (B-2) a compound represented by Formula (2) above and/or a polymer polymerized using at least a compound represented by Formula (2) above (hereinafter, also called component (B-2)).

The film forming composition of the present invention has a radical polymerization initiator added to component (B-1) and/or component (B-2). Adding a radical polymerization initiator to a compound having an unsaturated bond linked to an aromatic ring as in component (B-1) or component (B-2) enables the reaction efficiency to improve and the mechanical strength of a cured film to improve, and further enables the k value (specific permittivity) to be lowered due to a decrease in unreacted groups.

### (A) Radical Polymerization Initiator

The radical polymerization initiator used in the present invention is preferably one that exhibits activity by generating a free radical such as a carbon radical or an oxygen radical by means of heat, UV rays (UV), or an electron beam. An organic peroxide, an organic azo compound, an alkylphenone compound, and an oxime ester compound are particularly preferably used.

Preferred examples of the organic peroxide include diisobutyryl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, di(4-t-butylcyclohexyl)peroxydicarbonate, di(2-ethylhexyl)peroxydicarbonate, t-hexyl peroxyneodecanoate, t-butyl peroxyneodecanoate, t-butyl peroxyneoheptanoate, t-hexyl peroxypivalate, t-butyl peroxypivalate, di(3,5,5-trimethylhexanoyl)peroxide, dilauroyl peroxide, 1,1,3,3-tetramethylbutyl peroxy-2-ethylhexanoate, disuccinic acid peroxide, 2,5-dimethyl-2,5-di(2-ethylhexanoylperoxy)hexane, t-hexyl peroxy-2-ethylhexanoate, di(4-methylbenzoyl)peroxide, t-butyl peroxy-2-ethylhexanoate, di(3-methylbenzoyl)peroxide, benzoyl(3-methylbenzoyl)peroxide, dibenzoyl peroxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1-di(t-butylperoxy)cyclohexane, 2,2-di(4,4-di(t-butylperoxy)cyclohexyl)propane, t-hexyl peroxyisopropyl monocarbonate, t-butyl peroxymaleic acid, t-butyl peroxy-3,5,5-trimethylhexanoate, t-butyl peroxylaurate, t-butyl peroxyisopropyl monocarbonate, t-butyl peroxy-2-ethylhexyl monocarbonate, t-hexyl peroxybenzoate, 2,5-dimethyl-2,5-di(benzoylperoxy)hexane, t-butyl peroxyacetate, 2,2-di(t-butylperoxy)butane, t-butyl peroxybenzoate, n-butyl 4,4-di(t-butylperoxy)valerate, di(2-t-butylperoxyisopropyl)benzene, dicumyl peroxide, di-t-hexyl peroxide, 2,5-dimethyl-2,5-di(t-butylperoxy)hexane, t-butyl cumyl peroxide, di-t-butyl peroxide, p-menthane hydroperoxide, 2,5-dimethyl-2,5-di(t-butylperoxy)hexyne-3, diisopropylbenzene hydroperoxide, 1,1,3,3-tetramethylbutyl hydroperoxide, cumene hydroperoxide, t-butyl hydroperoxide, 2,3-dimethyl-2,3-diphenylbutane, 2,4-dichlorobenzoyl peroxide, o-chlorobenzoyl peroxide, p-chlorobenzoyl peroxide, tris(t-butylperoxy)triazine, 2,4,4-trimethylpentyl peroxyneodecanoate, α-cumyl peroxyneodecanoate, t-amylperoxy-2-ethyl hexanoate, t-butyl peroxyisobutylate, di-t-butyl peroxyhexahydroterephthalate, di-t-butyl peroxytrimethyladipate, di-3-methoxybutyl peroxydicarbonate, di-isopropyl peroxydicarbonate, t-butyl peroxyisopropyl carbonate, 1,6-bis(t-butylperoxycarbonyloxy)hexane, diethylene glycol bis(t-butyl peroxycarbonate), and t-hexylperoxy neodecanoate.

Preferred examples of the organic azo compound include 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutyronitrile), 1,1-azobis(cyclohexane-1-carbonitrile), 1-[(1-cyano-1-methylethyl)azo]formamide, 2,2-azobis{2-methyl-N-[1,1-bis(hydroxymethyl)-2-hydroxyethyl]propionamide}, 2,2-azobis{2-methyl-N-[2-(1-hydroxybutyl)]propionamide}, 2,2-azobis[2-methyl-N-(2-hydroxyethyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazolin-2-yl)propane]dihydrochloride, 2,2-azobis[2-(2-imidazolin-2-yl)propane]disulfate dihydrate, 2,2-azobis{2-[1-(2-hydroxyethyl)-2-imidazolin-2-yl]propane}dihydrochloride, 2,2-azobis[2-(2-imidazolin-2-yl)propane], 2,2-azobis(1-imino-1-pyrrolidino-2-methylpropane)dihydrochloride, 2,2-azobis(2-methylpropionamidine) dihydrochloride, 2,2-azobis[N-(2-carboxyethyl)-2-methylpropionamidine]tetrahydrate, dimethyl 2,2-azobis(2-methylpropionate), 4,4-azobis(4-cyanovaleric acid), and 2,2-azobis(2,4,4-trimethylpentane).

Preferred examples of the alkylphenone compound include 2,2-dimethoxy-1,2-diphenylethan-1-one, 1-hydroxycyclohexyl phenyl ketone, 2-hydroxy-2-methyl-1-phenyl-propan-1-one, 1-[4-(2-hydroxyethoxy)phenyl]-2-hydroxy-2-methyl-1-propan-1-one, 2-hydroxy-1-{4-[4-(2-hydroxy-2-methylpropionyl)benzyl]phenyl}-2-methylpropan-1-one, 2-benzyl-2-dimethylamino-1-(4-morpholinophenyl)butanone-1, and 2-(dimethylamino)-2-[(4-methylphenyl)methyl]-1-[4-(4-morpholinyl)phenyl]-1-butanone.

In the present invention, with regard to the radical polymerization initiator, one type thereof may be used on its own or two or more types may be used in combination.

In the present invention, the amount of polymerization initiator used, relative to 1 mol of the total number of moles of component (B-1), component (B-2), and other polymerizable compounds, is preferably 0.005 to 20 mol, more preferably 0.01 to 8 mol, and particularly preferably 0.1 to 2 mol. The total number of moles referred to here means the total number of moles of monomer units forming a polymer when component (B-1) is a polymer polymerized using at least a compound represented by Formula (1), and similarly means the total number of moles of monomer units forming a polymer when component (B-2) is a polymer polymerized using at least a compound represented by Formula (2).

### Component (B-1)

In the present invention, component (B-1) is a compound represented by Formula (1) below and/or a polymer polymerized using at least a compound represented by Formula (1) below.

### Compound Represented by Formula (1)

The compound represented by Formula (1) is explained.

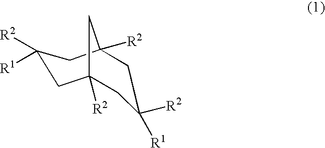

In Formula (1) above, the two R¹s denote groups consisting only of carbon and hydrogen, which may be identical to or different from each other and may be linked to each other to form a 6- or higher-membered ring structure.

Examples of R¹ include an alkyl group having 1 to 20 carbons (preferably, 1 to 6 carbons), an alkylene group having 1 to 20 carbons (preferably 1 to 6 carbons), an alkenyl group having 2 to 20 carbons (preferably 2 to 6 carbons), and an aryl group having 6 to 20 carbons (preferably 6 to 10 carbons), and among them an alkyl group is preferable. The alkyl group preferably has 1 to 5 carbons, and more preferably has 1 carbon, that is, it is a methyl group.

The two R¹s are preferably linked to each other to form a 6- or higher-membered ring structure, more preferably to form a 6- to 8-membered ring, and yet more preferably to form a 6-membered ring. When the R¹s form a 6-membered ring, the compound represented by Formula (1) has an adamantane skeleton.

In Formula (1) above, the R²s denote hydrogen atoms or are represented by Formula (3) below, and may be identical to or different from each other provided that at least one of the R²s is represented by Formula (3).

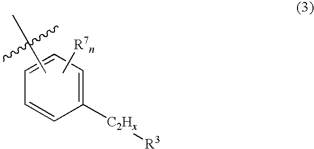

In Formula (3) above, the two carbon atoms in C₂Hₓ are linked via a double bond (—CH═CH—) or a triple bond (—C≡C—), and x denotes 0 or 2. C₂Hₓ is preferably linked via a triple bond, that is, it is preferably —C≡C—.

In Formula (3) above, R³ denotes a hydrogen atom, an alkyl group, an aryl group, a substituted aryl group, a heteroaryl group, an aryl ether group, an alkenyl group, or an alkynyl group. With regard to R³, the alkyl group preferably has 1 to 20 carbons, and more preferably 1 to 6 carbons, the substituted or unsubstituted aryl group preferably has 6 to 20 carbons, and more preferably 6 to 10 carbons, and the heteroaryl group is preferably a 5-membered ring to a 20-membered ring, and more preferably a 5-membered ring to a 10-membered ring, examples of the heteroatom including a nitrogen atom, an oxygen atom, and a sulfur atom. The aryl group forming the aryl ether group preferably has 6 to 20 carbons, and more preferably 6 to 10 carbons, and the alkenyl group preferably has 2 to 20 carbons, and more preferably 2 to 6 carbons. R³ is preferably a hydrogen atom, an alkyl group having 1 to 6 carbons, or an aryl group having 6 to 10 carbons, and more preferably a hydrogen atom, a methyl group, an ethyl group, a t-butyl group, or a phenyl group. Among them, R³ is preferably a hydrogen atom or a phenyl group, and particularly preferably a hydrogen atom.

In Formula (3) above, n is 4, R⁷ is a hydrogen atom or substituent bonded to the benzene ring, and the n (four) R⁷s may be identical to or different from each other and denote a hydrogen atom, an alkyl group, an aryl group, a substituted aryl group, or a halogen atom. The alkyl group preferably has 1 to 20 carbons, and more preferably 1 to 6 carbons, the aryl group preferably has 6 to 20 carbons, and more preferably 6 to 12 carbons, and examples of a substituent of the substituted aryl group include an alkyl group having 1 to 6 carbons, an aryl group having 6 to 20 carbons, and a halogen atom. Examples of the substituted or unsubstituted aryl group include a phenyl group and a biphenyl group. R⁷ is preferably a hydrogen atom or a halogen atom, and more preferably a hydrogen atom.

Preferred examples of the compound represented by Formula (1) are shown below, but the present invention is not limited thereto.

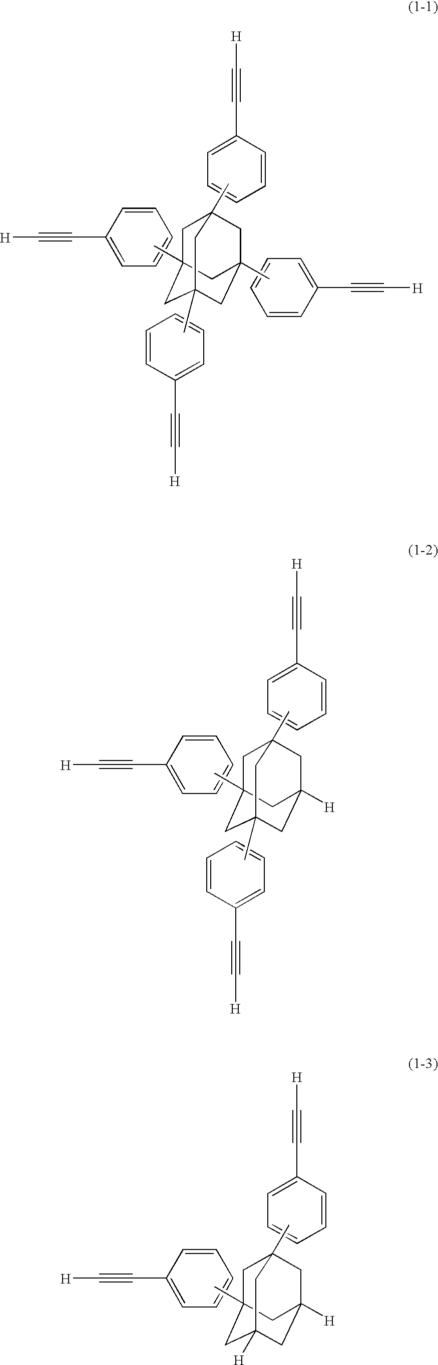

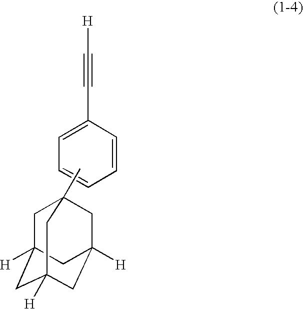

The molecular weight of the compound represented by Formula (1) is preferably 150 to 3,000, more preferably 200 to 2,000, and particularly preferably 220 to 1,000.

### Polymer Polymerized Using at Least Compound Represented by Formula (1)

The film forming composition of the present invention preferably comprises a compound represented by Formula (1) and/or a polymer polymerized using at least a compound represented by Formula (1). That is, the polymer has a compound represented by Formula (1) as a monomer unit.

The polymer polymerized using at least a compound represented by Formula (1) preferably comprises at least 10 mol % of a monomer unit derived from a compound represented by Formula (1) in the structure, more preferably at least 30 mol %, and yet more preferably at least 50 mol %.

Furthermore, the polymer polymerized using at least a compound represented by Formula (1) is preferably a polymer (homopolymer) in which only a compound represented by Formula (1) is polymerized or a copolymer with another compound having an adamantane skeleton, and is more preferably a polymer in which only a compound represented by Formula (1) is polymerized.

Preferred examples of the compound represented by Formula (1) used in the polymer are the same as those described above as preferred compounds for the compound represented by Formula (1).

With regard to the compound represented by Formula (1) used in the polymer, one type thereof may be used on its own, or two or more types may be used in combination.

A process for producing the polymer polymerized using at least a compound represented by Formula (1) is not particularly limited, but a process comprising a step of carrying out polymerization using at least a compound represented by Formula (1) in the presence of a polymerization initiator or a transition metal catalyst is preferable, and a process comprising a step of carrying out polymerization using at least a compound represented by Formula (1) in the presence of a radical polymerization initiator is more preferable.

The polymerization initiator is preferably a radical polymerization initiator. As the radical polymerization initiator, an organic peroxide or an organic azo compound is preferably used, and an organic peroxide is particularly preferable.

As the organic peroxide and the organic azo compound, those described above may preferably be used.

With regard to the polymerization initiator, only one type thereof may be used, or two or more types may be used in combination.

The amount of polymerization initiator used, per mole of the monomer, is preferably 0.001 to 2 moles, more preferably 0.01 to 1 moles, and particularly preferably 0.05 to 0.5 moles.

The polymerization reaction of the monomer is also preferably carried out in the presence of a transition metal catalyst. For example, a monomer having a polymerizable carbon-carbon double bond or carbon-carbon triple bond is preferably polymerized using a Pd-based catalyst such as tetrakistriphenylphosphine palladium (Pd(PPh₃)₄) or palladium acetate (Pd(OAc)₂), a Ni-based catalyst such as a Ziegler-Natta catalyst or nickel acetylacetonate, a W-based catalyst such as WCl₆, an Mo-based catalyst such as MoCl₅, a Ta-based catalyst such as TaCl₅, an Nb-based catalyst such as NbCl₅, a Rh-based catalyst, a Pt-based catalyst, etc.

With regard to the transition metal catalyst, only one type thereof may be used, or two or more types may be used in combination.

The amount of transition metal catalyst used, per mole of the monomer, is preferably 0.001 to 2 moles, more preferably 0.01 to 1 moles, and particularly preferably 0.05 to 0.5 moles.

The weight-average molecular weight of the polymer polymerized using at least a compound represented by Formula (1) is preferably 800 to 200,000, more preferably 2,000 to 100,000, and particularly preferably 5,000 to 50,000.

The polymer polymerized using at least a compound represented by Formula (1) may be contained in the film forming composition of the present invention as a resin composition having a molecular weight distribution.

A solvent used in the polymerization reaction may be any solvent as long as a starting monomer is soluble therein at a required concentration and the properties of a film formed from the polymer obtained are not adversely affected. Examples thereof include water, alcohol-based solvents such as methanol, ethanol, and propanol, ketone-based solvents such as acetone, methyl ethyl ketone, methyl isobutyl ketone, cyclohexanone, and acetophenone, ester-based solvents such as ethyl acetate, butyl acetate, propylene glycol monomethyl ether acetate, γ-butyrolactone, and methyl benzoate, ether-based solvents such as dibutyl ether and anisole, aromatic hydrocarbon-based solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-ortho-xylene, 1-methylnaphthalene, and 1,3,5-triisopropylbenzene, amide-based solvents such as N-methylpyrrolidinone and dimethylacetamide, halogen solvents such as carbon tetrachloride, dichloromethane, chloroform, 1,2-dichloroethane, chlorobenzene, 1,2-dichlorobenzene, and 1,2,4-trichlorobenzene, and aliphatic hydrocarbon-based solvents such as hexane, heptane, octane, and cyclohexane.

Among them, preferred solvents are acetone, methyl ethyl ketone, methyl isobutyl ketone, cyclohexanone, acetophenone, ethyl acetate, propylene glycol monomethyl ether acetate, γ-butyrolactone, anisole, tetrahydrofuran, toluene, xylene, mesitylene, 1,2,4,5-tetramethylbenzene, isopropylbenzene, t-butylbenzene, 1,4-di-t-butylbenzene, 1,3,5-tri-t-butylbenzene, 4-t-butyl-ortho-xylene, 1-methylnaphthalene, 1,3,5-triisopropylbenzene, 1,2-dichloroethane, chlorobenzene, 1,2-dichlorobenzene, and 1,2,4-trichlorobenzene, more preferred solvents are tetrahydrofuran, γ-butyrolactone, anisole, toluene, xylene, mesitylene, isopropylbenzene, t-butylbenzene, 1,3,5-tri-t-butylbenzene, 1-methylnaphthalene, 1,3,5-triisopropylbenzene, 1,2-dichloroethane, chlorobenzene, 1,2-dichlorobenzene, and 1,2,4-trichlorobenzene, and particularly preferred solvents are γ-butyrolactone, anisole, mesitylene, t-butylbenzene, 1,3,5-triisopropylbenzene, 1,2-dichlorobenzene, and 1,2,4-trichlorobenzene. They may be used singly or as a mixture of two or more types thereof.

The concentration of the monomer in a reaction mixture is preferably 1 to 50 wt %, more preferably 5 to 30 wt %, and particularly preferably 10 to 20 wt %.

Optimum conditions for the polymerization reaction in the present invention depend on the type, concentration, etc. of polymerization initiator, monomer, and solvent, but the internal temperature is preferably 0° C. to 200° C., more preferably 50° C. to 170° C., and particularly preferably 100° C. to 150° C., and the time is preferably 0.1 to 50 hours, more preferably 0.5 to 20 hours, and particularly preferably 0.75 to 10 hours.

Furthermore, it is preferable to carry out the reaction under an inert gas atmosphere (e.g. nitrogen, argon, etc.) in order to suppress deactivation of the polymerization initiator by oxygen. The oxygen concentration during the reaction is preferably no greater than 100 ppm, more preferably no greater than 50 ppm, and particularly preferably no greater than 20 ppm.

### Component (B-2)

In the present invention, component (B-2) is a general term for a compound represented by Formula (2) and/or a polymer polymerized using at least a compound represented by Formula (2).

### Compound Represented by Formula (2)

The compound represented by Formula (2) is explained below.

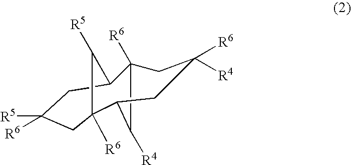

In Formula (2), the two R⁴s and the two R⁵s denote groups consisting only of carbon and hydrogen, which may be identical to or different from each other, and R⁴ and R⁴, and R⁵ and R⁵ may be linked to each other to form a 6- or higher-membered ring structure. Preferred ranges for R⁴ and R⁵ are the same as for R¹ in Formula (1).

With regard to the compound represented by Formula (2), it is preferable that R⁴ and R⁴, and R⁵ and R⁵ are linked to each other to form 6-membered rings. That is, the compound represented by Formula (2) preferably has a diamantane skeleton.

In Formula (2), the R⁶s denote hydrogen atoms or are represented by Formula (3) above, and may be identical to or different from each other provided that at least one R⁶ is represented by Formula (3). Formula (3) has the same meaning as one in Formula (1), and a preferred range is also the same.

Preferred examples ((2-1) to (2-4)) of the compound represented by Formula (2) are shown below, but the present invention is not limited thereto.

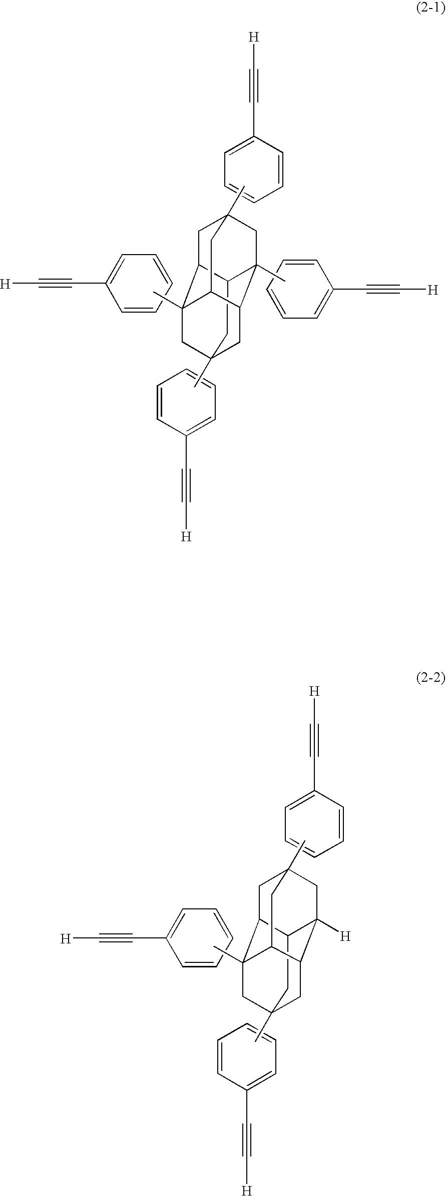

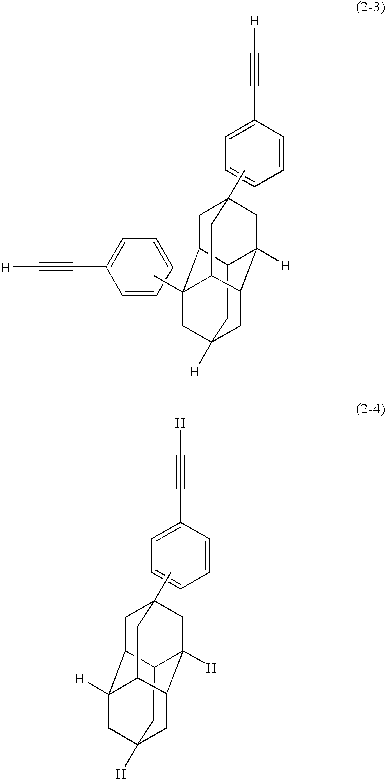

The molecular weight of the compound represented by Formula (2) is preferably 270 to 3,000, more preferably 275 to 2,000, and particularly preferably 285 to 1,000.

### Polymer Polymerized Using at Least Compound Represented by Formula (2)

The film forming composition of the present invention may comprise a compound represented by Formula (2) and/or a polymer polymerized using at least a compound represented by Formula (2). The polymer has a compound represented by Formula (2) as a monomer unit.

The polymer polymerized using at least a compound represented by Formula (2) preferably comprises at least 10 mol % of a monomer unit derived from a compound represented by Formula (2) in the structure, more preferably at least 30 mol %, and yet more preferably at least 50 mol %.

Furthermore, the polymer polymerized using at least a compound represented by Formula (2) is preferably a polymer (homopolymer) in which only a compound represented by Formula (2) is polymerized or a copolymer with another compound having a diamantane skeleton, and is more preferably a polymer in which only a compound represented by Formula (2) is polymerized.

Preferred examples of the compound represented by Formula (2) used in the polymer are the same as those described above as preferred compounds for the compound represented by Formula (2).

With regard to the compound represented by Formula (2) used in the polymer, one type thereof may be used on its own, or two or more types may be used in combination.

With regard to a process for producing a polymer polymerized using at least a compound represented by Formula (2), the same process as for the polymer polymerized using at least a compound represented by Formula (1) may be employed, and preferred reaction conditions are also the same.

The weight-average molecular weight of the polymer polymerized using at least a compound represented by Formula (2) is preferably 800 to 200,000, more preferably 2,000 to 100,000, and particularly preferably 5,000 to 50,000.

The polymer polymerized using at least a compound represented by Formula (2) may be contained in the film forming composition of the present invention as a resin composition having a molecular weight distribution.

### Amount Added

The total amount of component (B-1) and component (B-2) added in the film forming composition of the present invention is preferably 0.1 to 50 wt % relative to the total amount of the film forming composition, more preferably 1 to 40 wt %, and particularly preferably 1.5 to 20 wt %.

Furthermore, they are preferably added at 20 to 99.9 wt % relative to the solids content of the film forming composition, more preferably 40 to 99.7 wt %, and yet more preferably 60 to 99.5 wt %. The solids content referred to here corresponds to all components forming the film obtained using the film forming composition of the present invention.

Moreover, with regard to component (B-1) and component (B-2) in the film forming composition of the present invention, one type may be used on its own or two or more types may be used in combination. Therefore, a plurality of components (B-1) may be used, and a plurality of components (B-2) may be used. It is also possible to use component (B-1) and component (B-2) in combination. Among them, it is preferable to use only component (B-1) or component (B-2), and not to use the two in combination.

### Metal Content

It is preferable for the film forming composition of the present invention to have a sufficiently small content of metal as an impurity. The metal concentration of the film forming composition can be measured with high sensitivity by inductively-coupled plasma mass spectrometry (ICP-MS), and in this case the content of metals other than a transition metal is preferably no greater than 30 ppm, more preferably no greater than 3 ppm, and particularly preferably no greater than 300 ppb.

Furthermore, with regard to the transition metal, from the viewpoint of permittivity of a film obtained in the present invention being increased during pre-baking and thermal curing processes by an oxidation reaction due to high catalytic performance promoting oxidation, the content thereof is preferably as small as possible, and is preferably no greater than 10 ppm, more preferably no greater than 1 ppm, and particularly preferably no greater than 100 ppb.

The metal concentration of the film forming composition of the present invention may be evaluated by subjecting a film obtained using the film forming composition of the present invention to total reflection X-ray fluorescence spectrometry.

When W (tungsten) rays are used as a source of X-rays, K, Ca, Ti, Cr, Mn, Fe, Co, Ni, Cu, Zn, and Pd can be measured as metal elements, and each thereof is preferably no greater than 100×10¹⁰ atom·cm⁻², more preferably no greater than 50×10¹⁰ atom·cm⁻², and particularly preferably no greater than 10×10¹⁰ atom·cm⁻².

It is also possible to measure Br, which is a halogen, and the residual amount thereof is preferably no greater than 10,000×10¹⁰ atom·cm⁻², more preferably no greater than 1,000×10¹⁰ atom·cm⁻², and particularly preferably no greater than 400×10¹⁰ atom·cm⁻². It is also possible to measure Cl as halogen, and from the viewpoint of damage caused to CVD equipment, etching equipment, etc., the residual amount hereof is preferably no greater than 100×10¹⁰ atom·cm⁻², more preferably no greater than 50×10¹⁰ atom·cm⁻², and particularly preferably no greater than 10×10¹⁰ atom·cm⁻².

### Organic Solvent

The film forming composition of the present invention may comprise an organic solvent (coating solvent).

The organic solvent (coating solvent) is not particularly limited, and examples thereof include alcohol-based solvents such as methanol, ethanol, 2-propanol, 1-butanol, 2-ethoxymethanol, 3-methoxypropanol, and 1-methoxy-2-propanol, ketone-based solvents such as acetone, acetylacetone, methyl ethyl ketone, methyl isobutyl ketone, 2-pentanone, 3-pentanone, 2-heptanone, 3-heptanone, cyclopentanone, and cyclohexanone, ester-based solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate, and γ-butyrolactone, ether-based solvents such as diisopropyl ether, dibutyl ether, ethyl propyl ether, anisole, phenetole, and veratrole, aromatic hydrocarbon-based solvents such as mesitylene, ethylbenzene, diethylbenzene, propylbenzene, and t-butylbenzene, and amide-based solvents such as N-methylpyrrolidinone and dimethylacetamide, and they may be used singly or in a combination of two or more types.

More preferred organic solvents are 1-methoxy-2-propanol, propanol, acetylacetone, cyclohexanone, propylene glycol monomethyl ether acetate, butyl acetate, methyl lactate, ethyl lactate, γ-butyrolactone, anisole, mesitylene, and t-butylbenzene, and particularly preferred organic solvents are 1-methoxy-2-propanol, cyclohexanone, 2-heptanone, propylene glycol monomethyl ether acetate, ethyl lactate, γ-butyrolactone, t-butylbenzene, and anisole.

### Solids Content

The solids content of the film forming composition of the present invention is preferably 1 to 50 wt %, more preferably 2 to 15 wt %, and particularly preferably 3 to 10 wt %.

The solids referred to here correspond to all components constituting a film obtained using the composition.

The solubility of component (B-1) and component (B-2) at 25° C. in cyclohexanone or anisole is preferably at least 3 wt %, more preferably at least 5 wt %, and particularly preferably at least 10 wt %.

### Other Additives

Furthermore, an additive such as colloidal silica, a surfactant, a silane coupling agent, or an adhesion promoter may be added to the film forming composition of the present invention in a range that does not impair the properties (heat resistance, permittivity, mechanical strength, coating properties, adhesion, etc.) of a film obtained (preferably an insulating film).

### Colloidal Silica

As colloidal silica that can be used in the present invention, any colloidal silica may be used. For example, it is a dispersion in which high purity anhydrous silicic acid is dispersed in a hydrophilic organic solvent or water, the average particle size is preferably 5 to 30 nm, and more preferably 10 to 20 nm, and the solids content is preferably 5 to 40 wt %.

### Surfactant

As the surfactant that can be used in the present invention, any surfactant may be used. Examples thereof include a nonionic surfactant, an anionic surfactant, and a cationic surfactant, and further examples include a silicone-based surfactant, a fluorine-containing surfactant, a polyalkylene oxide-based surfactant, and an acrylic surfactant. With regard to the surfactant that can be used in the present invention, one type thereof or two or more types may be used. The surfactant is preferably a silicone-based surfactant, a nonionic surfactant, a fluorine-containing surfactant, or an acrylic surfactant, and particularly preferably a silicone-based surfactant.

The amount added of the surfactant that can be used in the present invention, relative to the total amount of the film forming composition, is at least 0.01 wt % but no greater than 1 wt %, and more preferably at least 0.1 wt % but no greater than 0.5 wt %.

The silicone-based surfactant referred to in the present invention is a surfactant containing at least one Si atom. As the silicone-based surfactant that can be used in the present invention, any silicone-based surfactant may be used, and a structure containing alkylene oxide and dimethylsiloxane is preferable. It is more preferable for it to be a structure containing the chemical formula below.

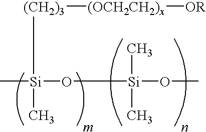

In the formula above, R is a hydrogen atom or an alkyl group having 1 to 5 carbons, x is an integer of 1 to 20, and m and n are independently integers of 2 to 100. Furthermore, where there are plurality of Rs, they may be identical to or different from each other.

Examples of the silicone-based surfactant that can be used in the present invention include BYK-306 and BYK-307 (BYK-Chemie), SH7PA, SH21PA, SH28PA, and SH30PA (Dow Corning Toray Silicone Co., Ltd.), and Troysol S366 (Troy Chemical Corporation, Inc.).

As the nonionic surfactant that can be used in the present invention, any nonionic surfactant may be used. Examples thereof include polyoxyethylene alkyl ethers, polyoxyethylene aryl ethers, polyoxyethylene dialkyl esters, sorbitan fatty acid esters, fatty acid-modified polyoxyethylenes, and polyoxyethylene-polyoxypropylene block copolymers.

As the fluorine-containing surfactant that can be used in the present invention, any fluorine-containing surfactant may be used. Examples thereof include perfluorooctyl polyethylene oxide, perfluorodecyl polyethylene oxide, and perfluorododecyl polyethylene oxide.

As the acrylic surfactant that can be used in the present invention, any acrylic surfactant may be used. Examples thereof include acrylic acid-based copolymers and methacrylic acid-based copolymers.

### Silane Coupling Agent

As the silane coupling agent that can be used in the present invention, any silane coupling agent may be used.

Examples of the silane coupling agent include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane.

With regard to the silane coupling agent that can be used in the present invention, one type thereof may be used on its own, or two or more types may be used in combination.

### Adhesion Promoter

As the adhesion promoter that can be used in the present invention, any adhesion promoter may be used.

Examples of the adhesion promoter include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate diisopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiouracil, mercaptoimidazole, mercaptopyrimidine, 1,1-dimethylurea, 1,3-dimethylurea, and a thiourea compound. A functionalized silane coupling agent is preferable as the adhesion promoter.

The amount of adhesion promoter used, relative to 100 parts by weight of the total solids content, is preferably no greater than 10 parts by weight, and is particularly preferably 0.05 to 5 parts by weight.

### Pore Forming Factor

The film forming composition of the present invention may employ a pore forming factor in a range that allows the film to have mechanical strength, thus making the film porous and giving low permittivity.

The pore forming factor as an additive that becomes a pore forming agent is not particularly limited, but a non-metallic compound is suitably used, and it is necessary to simultaneously satisfy solubility in a solvent that is used in the film forming composition and compatibility with component (B-1) and/or component (B-2).

Furthermore, the boiling point or decomposition temperature of the pore forming agent is preferably 100° C. to 500° C., more preferably 200° C. to 450° C., and particularly preferably 250° C. to 400° C.

The molecular weight is preferably 200 to 50,000, more preferably 300 to 10,000, and particularly preferably 400 to 5,000.

The amount thereof added, relative to the polymer forming a film, is preferably 0.5 to 75 wt %, more preferably 0.5 to 30 wt %, and particularly preferably 1 to 20 wt %.

Furthermore, as the pore forming factor, the polymer may contain a decomposable group, and the decomposition temperature thereof is preferably 100° C. to 500° C., more preferably 200° C. to 450° C., and particularly preferably 250° C. to 400° C. The content of the decomposable group, relative to the polymer forming a film, is preferably 0.5 to 75 mole %, more preferably 0.5 to 30 mole %, and particularly preferably 1 to 20 mole

### Process for Producing Film

In the present invention, the process for producing a film is not particularly limited as long as a film is formed using the film forming composition of the present invention, but the production process below is preferable. That is, it is preferably a process for producing a film comprising a step of preparing the film forming composition of the present invention, a step of applying the film forming composition in the form of a film, and at least one step selected from the group consisting of a step of heating the applied film forming composition, a step of irradiating the applied film forming composition with UV rays, and a step of irradiating the applied film forming composition with a high energy beam other than UV rays.

In particular, in the present invention, the process for producing a film preferably comprises a step of irradiating the applied film forming composition with UV rays.

A process for curing a film only by a heat treatment, which is conventionally used, sometimes has the problems that the treatment time is long and production takes a long time. A curing reaction is promoted by irradiation with UV rays, thus greatly reducing the time required for production. In particular, the film forming composition of the present invention comprises a radical polymerization initiator, and a curing reaction is yet further promoted by irradiation with UV rays. Therefore, irradiation with UV rays enables treatment time per wafer to be reduced, the curing reaction can be carried out more quickly than a thermal curing reaction, and it becomes possible to form a film having better mechanical strength.

That is, in the present invention, the process for producing a film preferably comprises (a) a step of applying the film forming composition in the form of a film, and at least one step selected from the group consisting of (b1) a step of heating the applied film forming composition, (b2) a step of irradiating the applied film forming composition with UV rays, and (b3) a step of irradiating the applied film forming composition with a high energy beam other than UV rays, more preferably comprises at least step (a) and step (b2), and yet more preferably comprises step (a), step (b1), and step (b2). Each step is explained below.

The heating step and the UV irradiation step, and the heating step and the high energy beam irradiation step may be carried out at the same time.

(a) Step of applying film forming composition

The step of applying the film forming composition of the present invention is not particularly limited, and it may be applied onto a substrate by a known method. Specific examples thereof include a spin coating method, a roller coating method, a dip coating method, and a scan method. As the method for coating the substrate, the spin coating method and the scan method are preferable. The spin coating method is particularly preferable. For spin coating, commercial equipment may be used. Preferred examples thereof include the Clean Track Series (Tokyo Electron Ltd.), the D-Spin Series (Dainippon Screen Manufacturing Co., Ltd.), and the SS Series or CS Series (Tokyo Ohka Kogyo Co., Ltd.). With regard to conditions for spin coating, any rotational speed may be employed, but from the viewpoint of in-plane uniformity of the film the rotational speed is preferably on the order of 1,300 rpm for a 300 mm silicon substrate.

Furthermore, a method for discharging the film forming composition may be either dynamic discharge in which the film forming composition is discharged onto a rotating substrate or static discharge in which the film forming composition is discharged onto a stationary substrate, and from the viewpoint of in-plane uniformity of the film, dynamic discharge is preferable. Furthermore, from the viewpoint of suppressing consumption of the composition, it is possible to employ a method in which after a liquid film is formed by preliminarily discharging only a main solvent of the composition onto a substrate, the composition is discharged thereonto. The spin coating time is not particularly limited, but from the viewpoint of throughput it is preferably within 180 sec. Furthermore, from the viewpoint of a substrate being transported, it is preferable to carry out a treatment (edge rinse, back rinse) for preventing film from being left on the edge of the substrate.

(b1) Step of Heating Applied Film Forming Composition

It is preferable to carry out a heating step in order to remove solvent contained in the film forming composition after applying the film forming composition.

A method for the heating treatment is not particularly limited, and hot plate heating, a heating method using a furnace, light irradiation heating using a xenon lamp by an RTP (Rapid Thermal Processor), etc., which are generally used, may be used. A heating method employing hot plate heating or a furnace is preferable. As a hot plate, commercial equipment may be preferably used, and the Clean Track Series (Tokyo Electron Ltd.), the D-Spin Series (Dainippon Screen Manufacturing Co., Ltd.), the SS Series or CS Series (Tokyo Ohka Kogyo Co., Ltd.), etc. may be preferably used. As a furnace, the α series (Tokyo Electron Ltd.), etc. may be preferably used.

Heating temperature and heating time in order to remove the solvent are preferably selected as appropriate depending on the type and amount of solvent used in the film forming composition, the amount of film forming composition coated, etc. For example, it is 400 to 300° C., it is preferably 50° C. to 250° C., and it is more preferably 60° C. to 200° C.

The heating time is for example 60 sec, preferably 10 to 300 sec, and more preferably 20 to 200 sec. It is preferable for the heating temperature to be in the above-mentioned range since the solvent can be removed effectively.

The heating treatment may be carried out not only for the purpose of removing the solvent but also for causing a polymerization reaction, and in this case the heating temperature is preferably 40° C. to 400° C., more preferably 50° C. to 350° C., and yet more preferably 60° C. to 300° C., and the heating time is preferably 1 to 60 minutes, more preferably 5 to 45 minutes, and yet more preferably 10 to 30 minutes.

The heating treatment may be carried out several times, and the atmosphere surrounding the substrate may be an inert atmosphere such as Ar, He, or nitrogen.

(b2) Step of Irradiating Applied Film Forming Composition with UV Rays

In the present invention, it is preferable to cure the film forming composition by irradiating the applied film forming composition with UV rays.

The UV irradiation wavelength region preferably includes wavelengths below 500 nm, is more preferably UV rays at 150 to 400 nm, and yet more preferably UV rays at 160 to 350 nm. It is preferable for the wavelength region to be in the above-mentioned range since it is easy to modify an organic material. The peak wavelength of the UV rays is preferably no greater than 500 nm, more preferably 150 to 400 nm, and yet more preferably 160 to 350 nm.

The output immediately above the substrate is preferably 0.1 to 5,000 mWcm⁻² more preferably 1 to 2,000 mWcm⁻², and yet more preferably 10 to 1,000 mWcm⁻². It is preferable for the output immediately above the substrate to be in the above-mentioned range since, although the higher the illumination intensity the shorter the time for the process, since the effect of irradiation is film thickness-dependent, the output can be reduced to some extent.

The irradiation time with UV rays is preferably no longer than 15 minutes, more preferably no longer than 10 minutes, and yet more preferably no greater than 3 minutes. The time is preferably at least 10 sec, more preferably at least 20 sec, and yet more preferably at least 30 sec. It is preferable for the illumination time with UV rays to be in the above-mentioned range since the film can be cured uniformly.

The substrate temperature when irradiated with UV rays is preferably 250° C. to 450° C., more preferably 250° C. to 400° C., and particularly preferably 250° C. to 350° C.

From the viewpoint of preventing oxidation of the polymer, the atmosphere surrounding the substrate is preferably an inert atmosphere such as Ar, He, or nitrogen. In this case, the pressure is preferably 0 to 133 kPa.

Irradiation with UV rays may be carried out a plurality of times, and in this case UV irradiation conditions need not be the same each time, and different conditions may be employed each time.

A heating treatment may be carried out after the irradiation with UV rays. The heating treatment temperature is preferably 200° C. to 400° C.

From the viewpoint of preventing oxidation of the polymer, it is preferable to carry out the heating after irradiation with UV rays using an inert atmosphere such as Ar, He, or nitrogen as the atmosphere surrounding the substrate. In this process, the pressure is preferably 0 to 133 kPa.

(b3) Step of Irradiating Applied Film Forming Composition with High Energy Beam Other than UV Rays

Furthermore, in the present invention, a polymerization reaction of carbon-carbon triple bonds present in component (B-1) and/or component (B-2) may be effected by irradiating with a high-energy beam before or after irradiation with UV rays, thus carrying out curing. Examples of the high-energy beam include an electron beam and X-rays, but are not particularly limited to these methods.

When an electron beam is used as the high energy beam, the energy is preferably 0 to 50 keV, more preferably 0 to 30 keV, and particularly preferably 0 to 20 keV. The total dose of the electron beam is preferably 0 to 5 μC/cm², more preferably 0 to 2 μC/cm², and particularly preferably 0 to 1 μC/cm². The substrate temperature when irradiating with an electron beam is preferably 0° C. to 450° C., more preferably 0° C. to 400° C., and particularly preferably 0° C. to 350° C. The pressure is preferably 0 to 133 kPa, more preferably 0 to 60 kPa, and particularly preferably 0 to 20 kPa. From the viewpoint of preventing oxidation of the polymer, the atmosphere surrounding the substrate is preferably an inert atmosphere such as Ar, He, or nitrogen. Furthermore, a gas such as oxygen, a hydrocarbon, or ammonia may be added for the purpose of a reaction with a plasma, an electromagnetic wave, or a chemical species generated by interaction with the electron beam. Irradiation with an electron beam in the present invention may be carried out a plurality of times, and in this case the conditions for irradiation with the electron beam need not be the same each time, and different conditions may be employed each time.

### Film

The film of the present invention is a film obtained using the film forming composition of the present invention, and may be used suitably as an insulating film.

It is preferable for the film obtained using the film forming composition of the present invention to have a desired specific permittivity according to an intended application, but the specific permittivity is preferably low, and the film is preferably an insulating film. For example, the specific permittivity is preferably no greater than 2.6, and more preferably no greater than 2.5.

Furthermore, the film obtained using the film forming composition of the present invention preferably has a high hardness and a high Young's modulus. The Young's modulus is preferably at least 5 GPa, more preferably 5.5 to 12 GPa, and yet more preferably 6 to 11 GPa.

Moreover, as a method for measuring the Young's modulus of the insulating film of the present invention, it is preferable to measure it using an SA2 Nanoindentor from MTS.

With regard to the film obtained using the film forming composition of the present invention, it is particularly preferable for both the specific permittivity and the Young's modulus to be in the above-mentioned ranges.

The film obtained using the film forming composition of the present invention may be suitably used as an insulating film, and more suitably as an interlayer insulating film for a semiconductor. That is, an insulating film obtained using the film forming composition of the present invention may be used suitably in an electronic device.

For example, when used as an interlayer insulating film for a semiconductor, in the wiring structure, a barrier layer for preventing metal migration may be provided on the wiring side face; furthermore, a cap layer, an interlayer adhesion layer, an etching stopper layer, etc. for preventing peeling off in CMP (Chemical Mechanical Polishing) may be provided on upper and lower faces of the wiring or the interlayer insulating film and, moreover, a layer of the interlayer insulating film may be divided into a plurality of layers using another type of material as necessary.

A film obtained using the film forming composition of the present invention may be subjected to an etching process for copper wiring or for another purpose. With regard to etching, either wet etching or dry etching may be employed, and dry etching is preferable. Dry etching may employ either an ammonia-based plasma or a fluorocarbon-based plasma as appropriate. These plasmas may employ not only Ar but also a gas such as oxygen, nitrogen, hydrogen, or helium. After etching, ashing may be carried out in order to remove a photoresist, etc. used for etching, and washing may be carried out in order to remove a residue after ashing.

A film obtained using the film forming composition of the present invention may be subjected to CMP after a copper wiring process in order to planarize a copper plated portion. As a CMP slurry (liquid reagent), a commercial slurry (e.g. those manufactured by Fujimi Inc., Rodel-Nitta, JSR Corporation, Hitachi Chemical Ltd., etc.) may be used as appropriate. As CMP equipment, commercial equipment (Applied Materials, Inc., Ebara Corporation, etc.) may be used as appropriate. Furthermore, in order to remove a slurry residue after CMP, washing may be carried out.

The film obtained using the film forming composition of the present invention may be used for various purposes. For example, it is suitable as an insulating film in a semiconductor device such as an LSI, a system LSI, a DRAM, an SDRAM, an RDRAM, or a D-RDRAM or an electronic component such as a multichip module multilayer wiring board, and it may be used as an interlayer insulating film for a semiconductor, an etching stopper film, a surface protecting film, a buffer coat film and, furthermore, as a passivation film in an LSI, an α-ray shielding film, a coverlay film for a flexible printed board, an overcoat film, a cover coat for a flexible copper-clad board, a solder resist film, a liquid crystal orientation film, etc.

Furthermore, in another application, the film of the present invention is doped with an electron donor or acceptor so as to impart electrical conductivity thereto, and may be used as an electrically conductive film.

### EXAMPLES

The Examples below explain the present invention, but should not be construed as limiting the scope thereof.

### Example 1-1

Polymerization of 2 parts by weight of 1,3-diphenylethynyladamantane, 0.4 parts by weight of dicumyl peroxide (PERCUMYL D, NOF Corporation), and 8.6 parts by weight of t-butylbenzene was carried out while stirring under a flow of nitrogen at an internal temperature of 130° C. for 1 hour. After the reaction mixture was cooled to room temperature, 79 parts by weight of methanol was added thereto, and a solid thus precipitated was filtered and washed with methanol. 1.0 part by weight of polymer (A) having a weight-average molecular weight of about 8,000 was obtained.

The solubility of polymer (A) in cyclohexanone was 20 wt % or greater at 25° C.

A coating solution was prepared by completely dissolving 1.0 part by weight of polymer (A) and 0.2 parts by weight of dicumyl peroxide in 9.5 parts by weight of cyclohexanone. This solution was filtered using a 0.1 μm tetrafluoroethylene filter, a silicon wafer was then spin-coated therewith, the coating was heated on a hot plate under a flow of nitrogen at 120° C. for 60 sec and then further calcined in a nitrogen-flushed oven at 400° C. for 60 minutes, and a 0.5 μm thick uniform film free of particulates was obtained.

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.48. Furthermore, the Young's modulus was measured using an SA2 Nanoindentor from MTS and was found to be 8.5 GPa.

### Example 1-2

Polymerization of 2 parts by weight of 1,3-diphenylethynyladamantane, 0.4 parts by weight of dicumyl peroxide (PERCUMYL D, NOF Corporation), and 8.6 parts by weight of t-butylbenzene was carried out while stirring under a flow of nitrogen at an internal temperature of 130° C. for 1 hour. After the reaction mixture was cooled to room temperature, 79 parts by weight of methanol was added thereto, and a solid thus precipitated was filtered and washed with methanol. 1.0 part by weight of polymer (A) having a weight-average molecular weight of about 8,000 was obtained.

The solubility of polymer (A) in cyclohexanone was 20 wt % or greater at 25° C.

A coating solution was prepared by completely dissolving 1.0 part by weight of polymer (A) and 0.2 parts by weight of 1-hydroxycyclohexyl phenyl ketone in 10 parts by weight of cyclohexanone. This solution was filtered using a 0.1 μm tetrafluoroethylene filter, a silicon wafer was then spin-coated therewith, the coating was heated on a hot plate under a flow of nitrogen at 250° C. for 60 sec, then irradiated with UV rays (wavelength 222 nm) at 110° C. for 30 minutes, and further calcined in a nitrogen-flushed oven at 400° C. for 30 minutes, and a 0.5 μm thick uniform film free of particulates was obtained.

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.49. Furthermore, the Young's modulus was measured using an SA2 Nanoindentor from MTS and was found to be 8.8 GPa.

### Example 1-3

Polymerization of 2 parts by weight of 1,3,5-triphenylethynyladamantane, 0.4 parts by weight of dicumyl peroxide (PERCUMYL D, NOF Corporation), and 8.6 parts by weight of t-butylbenzene was carried out while stirring under a flow of nitrogen at an internal temperature of 130° C. for 1 hour. After the reaction mixture was cooled to room temperature, 79 parts by weight of methanol was added thereto, and a solid thus precipitated was filtered and washed with methanol. 1.0 part by weight of polymer (B) having a weight-average molecular weight of about 17,000 was obtained.

The solubility of polymer (B) in cyclohexanone was 20 wt % or greater at 25° C.

A film forming composition was prepared by completely dissolving 1.0 part by weight of polymer (B) and 0.2 parts by weight of 1-hydroxycyclohexyl phenyl ketone in 10 parts by weight of cyclohexanone. This solution was filtered using a 0.1 μm tetrafluoroethylene filter, a silicon wafer was then spin-coated therewith, the coating was heated on a hot plate under a flow of nitrogen at 250° C. for 60 sec, then irradiated with UV rays (wavelength 222 nm) at 110° C. for 30 minutes, and further calcined in a nitrogen-flushed oven at 400° C. for 30 minutes, and a 0.5 μm thick uniform film free of particulates was obtained.

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.53. Furthermore, the Young's modulus was measured using an SA2 Nanoindentor from MTS and was found to be 10.5 GPa.

### Example 14

Polymerization of 2 parts by weight of 1,3-diphenylethynyladamantane, 0.4 parts by weight of dicumyl peroxide (PERCUMYL D, NOF Corporation), and 8.6 parts by weight of t-butylbenzene was carried out while stirring under a flow of nitrogen at an internal temperature of 140° C. for 1 hour. After the reaction mixture was cooled to room temperature, 79 parts by weight of methanol was added thereto, and a solid thus precipitated was filtered and washed with methanol. 1.0 part by weight of polymer (C) having a weight-average molecular weight of about 14,000 was obtained.

The solubility of polymer (C) in cyclohexanone was 20 wt % or greater at 25° C.

A coating solution was prepared by completely dissolving 1.0 part by weight of polymer (C) and 0.2 parts by weight of 1-hydroxycyclohexyl phenyl ketone in 10 parts by weight of cyclohexanone. This solution was filtered using a 0.1 μm tetrafluoroethylene filter, a silicon wafer was then spin-coated therewith, the coating was heated on a hot plate under a flow of nitrogen at 250° C. for 60 sec and then further calcined in a nitrogen-flushed oven at 400° C. for 60 minutes, and a 0.5 μm thick uniform film free of particulates was obtained.

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.48. Furthermore, the Young's modulus was measured using an SA2 Nanoindentor from MTS and was found to be 8.3 GPa.

### Example 1-5

Polymerization of 2 parts by weight of 4,9-diphenylethynyidiamantane, 0.4 parts by weight of dicumyl peroxide (PERCUMYL D, NOF Corporation), and 8.6 parts by weight of t-butylbenzene was carried out while stirring under a flow of nitrogen at an internal temperature of 130° C. for 1 hour. After the reaction mixture was cooled to room temperature, 79 parts by weight of methanol was added thereto, and a solid thus precipitated was filtered and washed with methanol. 1.0 part by weight of polymer (D) having a weight-average molecular weight of about 8,000 was obtained.

The solubility of polymer (D) in cyclohexanone was 20 wt % or greater at 25° C.

A coating solution was prepared by completely dissolving 1.0 part by weight of polymer (D) and 0.2 parts by weight of dicumyl peroxide in 9.5 parts by weight of cyclohexanone. This solution was filtered using a 0.1 μm tetrafluoroethylene filter, a silicon wafer was then spin-coated therewith, the coating was heated on a hot plate under a flow of nitrogen at 120° C. for 60 sec and then further calcined in a nitrogen-flushed oven at 400° C. for 60 minutes, and a 0.5 μm thick uniform film free of particulates was obtained.

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.43. Furthermore, the Young's modulus was measured using an SA2 Nanoindentor from MTS and was found to be 9.5 GPa.

### Comparative Example 1-1

Polymerization of 2 parts by weight of 1,3-diphenylethynyladamantane, 0.4 parts by weight of dicumyl peroxide (PERCUMYL D, NOF Corporation), and 8.6 parts by weight of t-butylbenzene was carried out while stirring under a flow of nitrogen at an internal temperature of 130° C. for 1 hour. After the reaction mixture was cooled to room temperature, 79 parts by weight of methanol was added thereto, and a solid thus precipitated was filtered and washed with methanol. 1.0 part by weight of polymer (A) having a weight-average molecular weight of about 8,000 was obtained.

The solubility of polymer (A) in cyclohexanone was 20 wt % or greater at 25° C.

A coating solution was prepared by completely dissolving 1.0 part by weight of polymer (A) in 9.5 parts by weight of cyclohexanone. This solution was filtered using a 0.1 μm tetrafluoroethylene filter, a silicon wafer was then spin-coated therewith, the coating was heated on a hot plate under a flow of nitrogen at 120° C. for 60 sec and then further calcined in a nitrogen-flushed oven at 400° C. for 60 minutes, and a 0.5 μm thick uniform film free of particulates was obtained.

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.49. Furthermore, the Young's modulus was measured using an SA2 Nanoindentor from MTS and was found to be 4.0 GPa.

TABLE 1

| | Ex. 1-1 | Ex. 1-2 | Ex. 1-3 | Ex. 1-4 | Ex. 1-5 | Comp. Ex. 1-1 |
|---|---|---|---|---|---|---|
| Polymer | A | A | B | C | D | A |
| Weight-average molecular weight | 8,000 | 8,000 | 17,000 | 14,000 | 8,000 | 8,000 |
| Specific permittivity | 2.48 | 2.49 | 2.53 | 2.48 | 2.43 | 2.49 |
| Young's modulus (GPa) | 8.5 | 8.8 | 10.5 | 8.3 | 9.5 | 4.0 |

### Example 2-1

A coating solution was prepared by completely dissolving 1.0 part by weight of polymer (A) and 0.2 parts by weight of dicumyl peroxide in 10 parts by weight of cyclohexanone. This solution was filtered using a 0.1 μm tetrafluoroethylene filter, a silicon wafer was then spin-coated therewith, the coating was heated on a hot plate under a flow of nitrogen at 120° C. for 60 sec, and a 0.5 μm thick uniform film free of particulates was obtained.

The film thus obtained was placed on a hot plate at 350° C. and irradiated with UV rays in a nitrogen atmosphere at 1 Pa for 3 minutes using a dielectric barrier discharge lamp, manufactured by Ushio Inc., which is capable of emitting UV rays at a wavelength of 172 nm, thus giving an insulating film. In this process, the output immediately above the substrate was 10 mWcm⁻².

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.31. Furthermore, the Young's modulus was measured using an SA2 Nanoindentor from MTS and was found to be 9.5 GPa.

### Example 2-2

A coating solution was prepared by completely dissolving 1.0 part by weight of polymer (A) and 0.2 parts by weight of 1-hydroxycyclohexyl phenyl ketone in 10 parts by weight of cyclohexanone. This solution was filtered using a 0.1 μm tetrafluoroethylene filter, a silicon wafer was then spin-coated therewith, the coating was heated on a hot plate under a flow of nitrogen at 250° C. for 60 sec, and then irradiated with UV rays (dielectric barrier discharge lamp, wavelength 222 nm, Ushio Inc.) in a nitrogen-flushed atmosphere for 10 minutes on a hot plate at 300° C., and a 0.5 μm thick uniform film free of particulates was obtained. The UV irradiation was carried out at 1 Pa. In this process, the output immediately above the substrate (silicon wafer) was 5 mWcm⁻².

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.30. Furthermore, the Young's modulus was measured using an SA2 Nanoindentor from MTS and was found to be 9.8 GPa.

### Example 2-3

Polymerization of 2 parts by weight of 1,3,5-triphenylethynyladamantane, 0.4 parts by weight of dicumyl peroxide (PERCUMYL D, NOF Corporation), and 8.6 parts by weight of t-butylbenzene was carried out while stirring under a flow of nitrogen at an internal temperature of 130° C. for 1 hour. After the reaction mixture was cooled to room temperature, 79.1 parts by weight of methanol was added thereto, and a solid thus precipitated was filtered and washed with methanol. 1.0 part by weight of polymer (B) having a weight-average molecular weight of about 17,000 was obtained.

The solubility of polymer (B) in cyclohexanone was 20 wt % or greater at 25° C.

A coating solution was prepared by completely dissolving 1.0 part by weight of polymer (B) and 0.2 parts by weight of 1-hydroxycyclohexyl phenyl ketone in 10 parts by weight of cyclohexanone. This solution was filtered using a 0.1 μm tetrafluoroethylene filter, a silicon wafer was then spin-coated therewith, the coating was heated on a hot plate under a flow of nitrogen at 250° C. for 60 sec, then irradiated with UV rays (wavelength 222 nm) at 110° C. for 1.5 minutes, and further calcined on a nitrogen-flushed hot plate at 300° C. for 3 minutes, and a 0.5 μm thick uniform film free of particulates was obtained. The UV irradiation was carried out at 1 Pa. In this process, the output immediately above the substrate (silicon wafer) was 5 mWcm⁻².

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.47. Furthermore, the Young's modulus was measured using an SA2 Nanoindentor from MTS and was found to be 8.0 GPa.

### Comparative Example 2-1

Polymerization was carried out while stirring 2 parts by weight of 1,3,5-triphenylethynyladamantane, 0.4 parts by weight of dicumyl peroxide (PERCUMYL D, NOF Corporation), and 8.6 parts by weight of t-butylbenzene under a flow of nitrogen at an internal temperature of 130° C. for 1 hour. After the reaction mixture was cooled to room temperature, 79.1 parts by weight of methanol was added thereto, and a solid thus precipitated was filtered and washed with methanol. 1.0 part by weight of polymer (B) having a weight-average molecular weight of about 17,000 was obtained.

The solubility of polymer (B) in cyclohexanone was 20 wt % or greater at 25° C.

A coating solution was prepared by completely dissolving only polymer (B) in 10 parts by weight of cyclohexanone. This solution was filtered using a 0.1 μm tetrafluoroethylene filter, a silicon wafer was then spin-coated therewith, the coating was heated on a hot plate at 300° C. for 10 minutes in a nitrogen-flushed atmosphere, and a 0.5 μm thick uniform film free of particulates was obtained.

The specific permittivity of the film was calculated from a capacitance value at 1 MHz using a mercury probe manufactured by Four Dimensions Inc. and an HP4285ALCR meter manufactured by Yokogawa Hewlett-Packard Company, and was found to be 2.45. Furthermore, the Young's modulus was measured using an SA2 Nanoindentor from MTS and was found to be 3.5 GPa.

The results are given in Table 2.

TABLE 2

| | Ex. 2-1 | Ex. 2-2 | Ex. 2-3 | Comp. Ex. 2-1 |
|---|---|---|---|---|
| Specific permittivity | 2.31 | 2.3 | 2.47 | 2.45 |
| Young's modulus (GPa) | 9.5 | 9.8 | 8.0 | 3.5 |

It has been found that films (insulating films) formed using the film forming composition of the present invention have excellent curability and low permittivity.

What is claimed is:

1. A film forming composition comprising:
(A) a radical polymerization initiator; and
(B-1) a compound represented by Formula (1) below and/or a polymer polymerized using at least a compound represented by Formula (1) below, and/or (B-2) a compound represented by Formula (2) below and/or a polymer polymerized using at least a compound represented by Formula (2) below 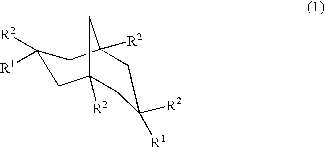
(in Formula (1), the two R¹s denote groups consisting only of carbon and hydrogen, which may be identical to or different from each other, and may be linked to each other to form a 6- or higher-membered ring structure, and the R²s denote hydrogen atoms or are represented by Formula (3) below and may be identical to or different from each other provided that at least one of the R²s is represented by Formula (3)) 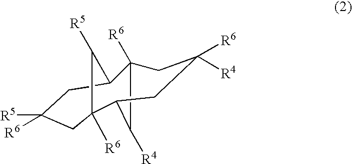
(in Formula (2), the two R⁴s and the two R⁵s denote groups consisting only of carbon and hydrogen, which may be identical to or different from each other, R⁴ and R⁴, and R⁵ and R⁵ may be linked to each other to form a 6- or higher-membered ring structure, and the R⁶s denote hydrogen atoms or are represented by Formula (3) and may be identical to or different from each other provided that at least one R⁶ is represented by Formula (3)) 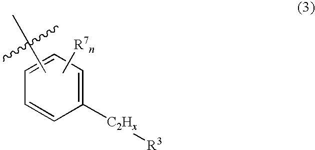
(in Formula (3), the two carbon atoms in C₂Hₓ are linked via a double bond or a triple bond, x denotes 0 or 2, R³ denotes a hydrogen atom, an alkyl group, an aryl group, a substituted aryl group, a heteroaryl group, an aryl ether group, an alkenyl group, or an alkynyl group, n is 4, and the n R⁷s may be identical to or different from each other and denote a hydrogen atom, an alkyl group, an aryl group, a substituted aryl group, or a halogen atom).

2. The film forming composition according to claim 1, wherein the radical polymerization initiator comprises at least one selected from the group consisting of an organic peroxide, an organic azo compound, an alkylphenone compound, and an oxime ester compound.

3. The film forming composition according to claim 1, wherein the compound represented by Formula (1) above is selected from the group consisting of Formula (1-1) to Formula (1-4) below.

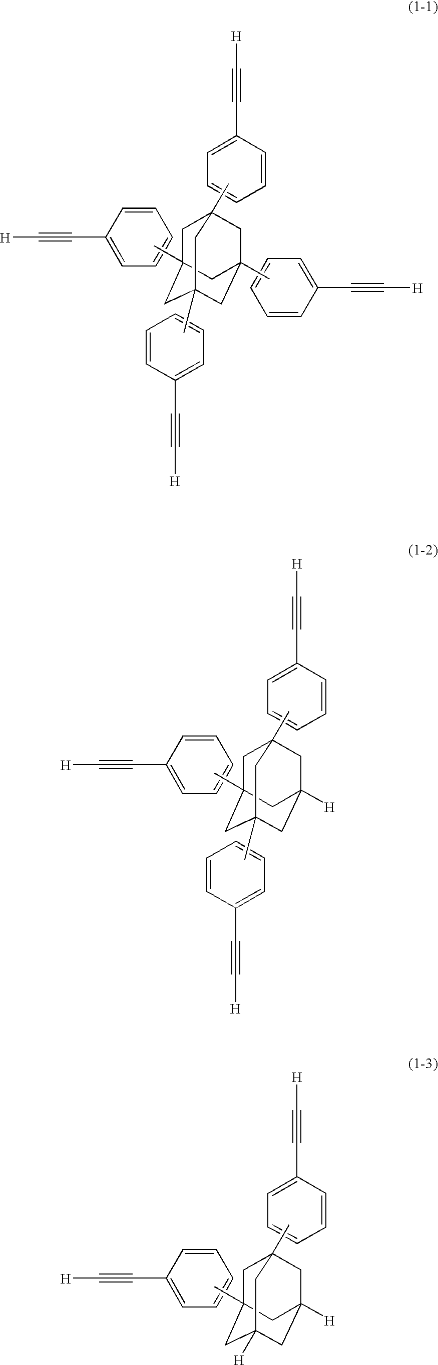

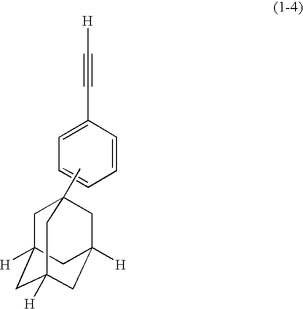

4. The film forming composition according to claim 1, wherein the compound represented by Formula (2) above is selected from the group consisting of Formula (2-1) to Formula (2-4) below.

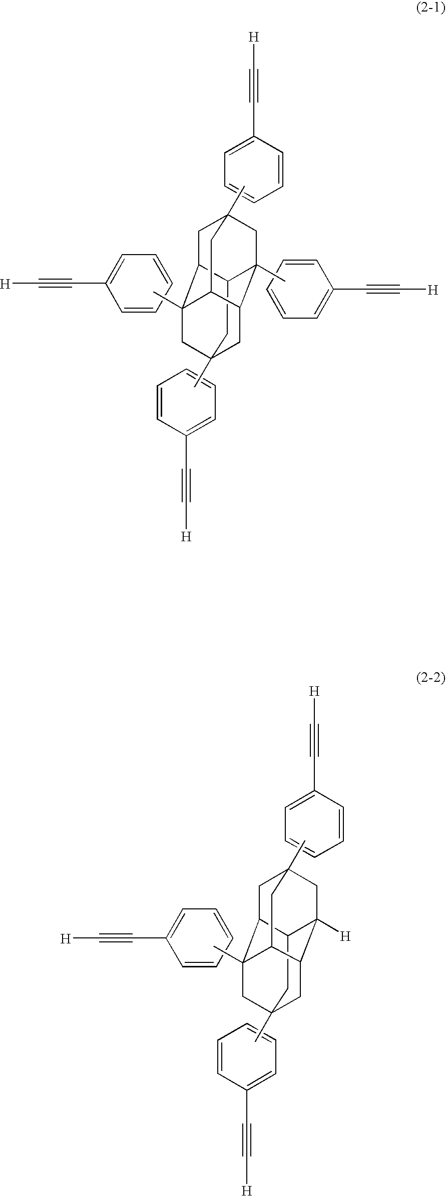

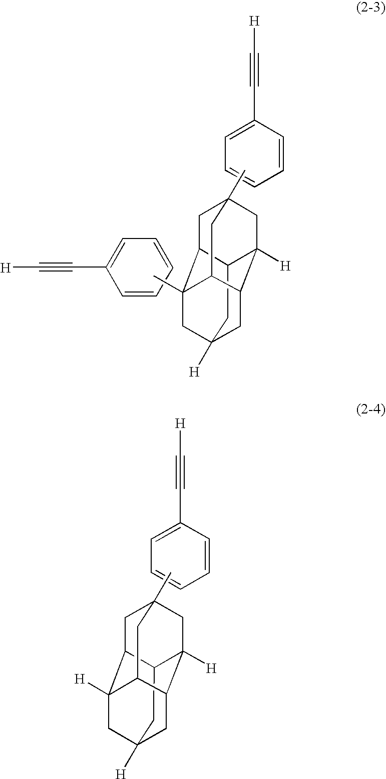

5. The film forming composition according to claim 1, wherein the total amount of component (B-1) and component (B-2) added is at least 0.1 wt % but no greater than 50 wt % of the total amount of the film forming composition.

6. The film forming composition according to claim 1, wherein it further comprises an organic solvent.

7. The film forming composition according to claim 1, wherein it further comprises at least one additive selected from the group consisting of colloidal silica, a surfactant, a silane coupling agent, an adhesion promoter, and a pore forming factor.

8. The film forming composition according to claim 1, wherein it is intended for use in forming an insulating film.

9. A process for producing a film, the process comprising:
a step of preparing the film forming composition according to claim 1;
a step of applying the film forming composition in the form of a film; and
at least one step selected from the group consisting of a step of heating the applied film forming composition, a step of irradiating the applied film forming composition with UV rays, and a step of irradiating the applied film forming composition with a high energy beam other than UV rays.

10. The process according to claim 9, wherein it comprises a step of irradiating the applied film forming composition with UV rays.

11. The process according to claim 10, wherein the UV rays have a wavelength of no greater than 500 nm.

12. The process according to claim 10, wherein the time of irradiation with UV rays is no greater than 3 minutes.

13. The process according to claim 9, wherein it comprises a step of heating the applied film forming composition and a step of irradiating the applied film forming composition with UV rays.

14. The process according to claim 13, wherein it comprises a step of irradiating with a high energy beam other than UV rays.

15. The process according to claim 9, wherein the film is an insulating film.

16. A film obtained by the process according to claim 9.
